(19) United States
(12) Patent Application Publication
(10) Pub. No.: US 2026/0077528 A1
(43) Pub. Date: Mar. 19, 2026

(54) METHOD FOR AUTOMATICALLY POSITIONING DEFECTS OF A COUPON OF FLEXIBLE MATERIAL HAVING NON-HOMOGENEOUS CHARACTERISTICS

(71) Applicant: LECTRA, Paris (FR)

(72) Inventor: Sylvain GUILBERT, Saint-Quentin-de-Baron (FR)

(21) Appl. No.: 19/108,509

(22) PCT Filed: Sep. 29, 2023
(86) PCT No.: PCT/FR2023/051503

§ 371 Date: Mar. 4, 2025

(30) Foreign Application Priority Data
Oct. 24, 2022 (FR) 2211029

(51) Int. Cl. B26D 5/00; B26D 7/01

(52) U.S. Cl. CPC B26D 5/005; B26D 7/01

(57) ABSTRACT

A method includes obtaining an image of the contour of the coupon in its initial state and the position of the defects, after repositioning the coupon in a state ready for cutting; obtaining a new image of the contour of the coupon; superimposing the two images; determining a rotation value to be applied to one of the two contours to minimize the total surface area of the zones that do not overlap; applying the rotation value to the position of each defect in the image of the coupon in its initial state to pre-position each defect; determining geometric transformations to locally minimize the surface area of the zones of the two contours that do not intersect; and applying to the position of each pre-positioned defect based on its position inside the contour to accurately reposition it inside the image of the coupon in its state ready for cutting.

### TECHNICAL FIELD

The invention concerns the cutting of pieces from coupons of flexible material with non-homogeneous characteristics, in particular leathers or natural skins.

A field of application of the invention is the one of the manufacture of articles, particularly leather, requiring the assembly of pieces cut from such coupons. The industries concerned are in particular furniture, saddlery, leather, footwear and clothing industries.

### PRIOR ART

The automatic cutting of pieces from leathers or natural skins for the purpose of manufacturing an article has typically several main steps, namely: a first step of digitizing the contour and defects of the skin, followed by a second step which consists in placing as many pieces as possible on the digitized skin, then a third step of cutting the pieces from the skin by following the pre-established placement, and finally a fourth step which consists in unloading the cut pieces.

Depending on how these main steps are chained together, this leads to different cutting methods.

Thus, according to a cutting method called “online” cutting method, the four main steps described above are performed one after the other on the same cutting table.

The advantage of this method lies in its simplicity in terms of organization for the user, as well as in the responsiveness and flexibility it allows (in terms of organization planning). On the other hand, the main drawback of such a method is the difficulty in properly synchronizing and balancing all the main steps. Indeed, if one of these steps takes longer than expected, there is a great risk of slowing down the overall method.

According to another method called “offline” method, the steps of digitizing the skin, placing the pieces, then cutting and unloading the pieces are performed separately, on different equipment and with time intervals between these steps left to the discretion of the user.

The advantages and drawbacks of this method are the opposite of those encountered with the “online” method. Particularly, the separation of the main steps makes it possible to manage those that take longer than the others (for example by adapting the number of digitizers relative to the number of cutters, and/or by adapting the calculation time dedicated to the placement of the pieces). Conversely, this “offline” method requires greater organization on the part of the user, as well as additional handling (even storage) of skins between the steps.

Another drawback of this method lies in the introduction of a new step compared to the “online” method, which consists in repositioning a previously digitized skin on the cutting machine. Indeed, it is not easy in terms of ergonomics to reposition a skin in the same way. In addition, this handling always generates additional inaccuracies that must be taken into account during the placement of the pieces by keeping a sufficiently large unused space at the border of the skin, which reduces the efficiency of the placement.

There is still another method called “semi-offline” method which consists of an intermediate method between the “online” and “offline” methods described above. In this method, only the step of digitizing the contour and the defects of the skins is transferred to another equipment and is desynchronized from the other main steps. Indeed, the digitization of the defects of a skin is often the most time-consuming step, and the quality of this digitization (namely the consideration of all the defects, their exact location without enlarging them) will determine the efficiency of the placement and the reduction in the rate of the rejected pieces.

The drawback of this “semi-offline” method (just like in the “offline” method) lies in the difficulty for an operator to reposition the skin. On the other hand, in this method, the placement of the pieces on the skin has not yet taken place and will be done inside the true contour that will be digitized again after the repositioning step. Unlike the “offline” method, it is therefore not necessary to provide for an additional margin at the border of the skin, which is beneficial for the efficiency of the placement.

The difficulty of such a “semi-offline” method lies, on the one hand, in the ease of the skin repositioning phase, and on the other hand in the accuracy of (automatic) repositioning of the defects inside the new digitized contour of the skin.

Indeed, leather is a flexible material that deforms more or less depending on how an operator positions the skin on the table during the first digitization and on how another operator will reposition this same skin on another table during the second digitization. However, the way in which the skin deforms has direct consequences on the positioning of the defects.

In addition to these deformations of the skin due to the different ways in which the operators display it on a table, the skin may have remained for several weeks or even months between the two digitization steps. However, the storage conditions as well as possible differences in humidity and temperature between the two digitization steps also impact the possible deformations of the skin, and therefore the positioning of the defects.

In addition, the positioning of the skin during the first digitization step is generally performed on a digitizer having a relatively smooth polyurethane conveyor, while the repositioning of the skin defects during the new digitization is performed on a cutting machine with a felt conveyor that has a strong grip with the skin. This can still lead to additional difficulties in successfully conducting the step of repositioning the defects of the skin.

The multiple deformations undergone by the skin described above are unfortunately not homogeneous and are therefore not predictable. Also, the defect repositioning step must be capable of finding as accurately as possible the position of the contour and of all the defects of the skin.

To solve this issue of repositioning the defects, it is known to use video projectors that project an image of the entire skin (or only a part of it) previously digitized on the skin laid on the cutting machine. The operator then proceeds by nibbling to reposition the entire skin and its defects.

However, this method remains quite weak in terms of ergonomics and accuracy. Indeed, the operator must correct the position of the skin edges (by relying on the projected contour, which is not very accurate) by pulling on the latter, which may cause strong tensions near the skin edges.

### DISCLOSURE OF THE INVENTION

The main aim of the invention is therefore to overcome such drawbacks by proposing a method for positioning the defects by an automatic calculation of the position of the defects that is simple and ergonomic.

In accordance with the invention, this aim is achieved thanks to a method for automatically positioning defects in a coupon of flexible material with non-homogeneous characteristics from which pieces are intended to be cut, comprising the successive steps of:
obtaining a digital image of the contour of the coupon in its initial state and the position of its defects;
after repositioning the coupon in a state ready for cutting, obtaining a new digital image of the contour of the coupon;
superimposing the digital images of the contours of the coupon in its initial state and in its state ready for cutting;
determining a rotation value to be applied to at least one of the two contours in order to minimize the total surface area of the zones delimited by the two contours that do not overlap;
applying the rotation value to the position of each defect in the digital image of the coupon in its initial state in order to pre-position each defect inside the digital image of the coupon in its state ready for cutting;
determining a plurality of geometric transformations to locally minimize the surface area of the zones of the two contours that do not overlap; and
applying to the position of each pre-positioned defect inside the digital image of the coupon in its state ready for cutting, one of the geometric transformations as a function of the position of the defect inside the contour of the coupon in its initial state in order to accurately reposition the defect inside the digital image of the coupon in its state ready for cutting.

The method according to the invention is remarkable in that it provides for a defect repositioning algorithm that allows applying to the position of each defect a specific geometric transformation that depends on the location of the defect inside the contour of the coupon. In other words, the geometric deformation applied to each defect is not the same for all the defects. The method thus makes it possible to reposition automatically and with great accuracy all of the defects of the coupon.

Moreover, the method according to the invention only requires a simple linear scanner (or one or more matrix cameras) at the input of the conveyor cutting machine that can be identical to the one used during the digitization step. The coupon is thus simply laid by the operator on the scanner at the location and in the way he wishes. Particularly, this solution allows the users of cutters adapted to an “online” method to use it to implement a “semi-offline” method without any hardware modification of their cutter.

Preferably, the rotation of the digital images of the contours of the coupon is carried out relative to the respective barycenters of the two contours after having been superimposed.

The geometric transformations may each comprise a rotation component and a homothety ratio component.

In this case, in a polar coordinate system whose origin is constituted by the respective barycenter of the two contours, a discrete field of angular sectors covering the two contours is advantageously constructed and geometric transformations whose rotation and homothety ratio components are determined are associated with each angular sector in order to locally minimize the surface area of the zones of the two contours that do not overlap.

Preferably, the rotation and homothety ratio components of each geometric transformation are determined by dichotomy in order to obtain the rotation and homothety ratio values that minimize the surface area of the non-overlapping zones of the portions of the two contours concerned by the angle value associated with the geometric transformation.

The step of applying one of the geometric transformations to each pre-positioned defect can apply to each of the vertices of a polygon encompassing the contour of the defect.

In this case, for each vertex of each polygon encompassing the contour of a defect, the two angles that geometrically frame this vertex are advantageously identified, and a combination of the rotation and homothety ratio values of the two geometric transformations associated with the two corresponding angle values is applied to the coordinates of the vertex.

The invention also relates to a method for cutting pieces from coupons of flexible material with non-homogeneous characteristics, comprising:
a step of digitizing the contour of the coupons in their initial state and the position of their defects;
for each coupon, a new step of digitizing the contour of the coupon on a digitizing and cutting table;
a step of automatically positioning the defects of the coupon according to the method as defined previously;
a step of placing pieces to be cut from the coupon; and
a step of cutting the pieces.

The invention also relates to a computer program including instructions for the execution of the steps of the method for automatically positioning defects in a coupon of flexible material with non-homogeneous characteristics as defined above.

The invention also relates to a computer-readable recording medium on which is recorded a computer program comprising instructions for the execution of the steps of the method for automatically positioning defects in a coupon of flexible material with non-homogeneous characteristics as defined above.

### BRIEF DESCRIPTION OF THE DRAWINGS

FIG. 1 is a flowchart illustrating the main steps of a “semi-offline” piece cutting method according to the invention.

FIG. 2 is another flowchart illustrating the main steps of a defect positioning method according to the invention.

FIGS. 3 to 11 represent exemplary implementations of the different steps of the defect positioning method according to the invention.

### DESCRIPTION OF THE EMBODIMENTS

The invention applies to the cutting of pieces from coupons of flexible material with non-homogeneous characteristics, in particular from leathers or natural skins, for the purpose of manufacturing an article.

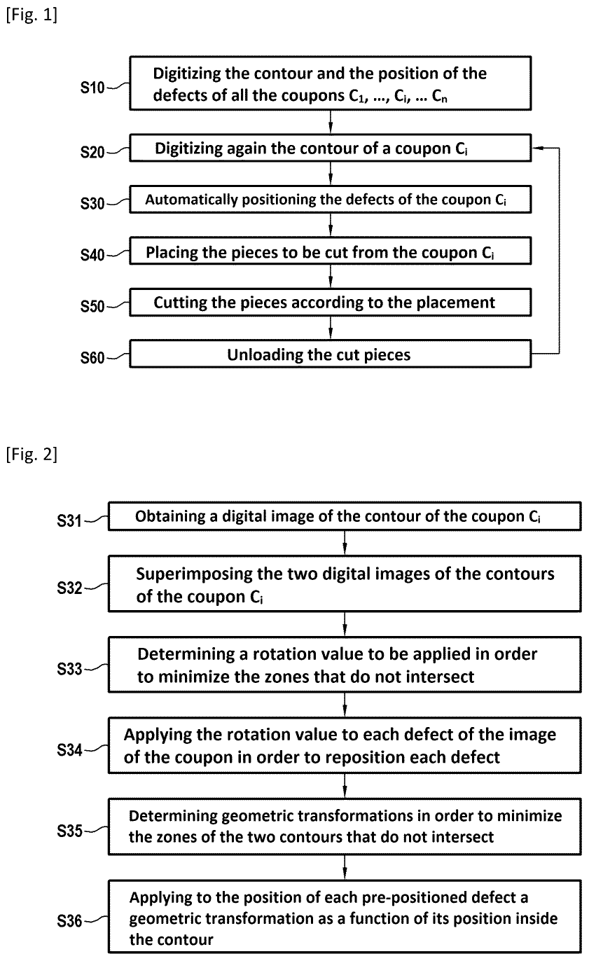

More specifically, the invention is integrated into a cutting method called “semi-offline” cutting method whose main steps are described in the flowchart of FIG. 1.

During the initial step S10 of this method, it is planned to digitize the contour of all the coupons C₁, . . . , Cᵢ, . . . Cₙ in their initial state and to accurately determine the position of the defects of these coupons inside their contour. The digitization of the position of the defects can be carried out automatically using the scanner or an operator.

This initial step of digitizing the coupons is carried out on a digitizing table equipped with a scanner and is desynchronized compared to the other steps of the cutting method. The digital data of the coupons C₁, . . . , Cᵢ, . . . Cₙ are stored and the digitized coupons can then be stowed in a storage location.

Each coupon Cᵢ is then removed from its storage location in order to be positioned flat on a cutting table provided with a scanner at the input where it undergoes a new step of digitizing its contour (step S20).

The next step consists in automatically repositioning the defects of the coupon Cᵢ ready for cutting inside its contour according to the method of the invention. This involves a repositioning from the data stored during step S10, and not a new positioning of these defects. This step S30 is detailed later.

The next step S40 consists in placing the pieces to be cut inside the contour of the coupon Cᵢ. Typically, the placement of the pieces to be cut takes into account the geometric shape of these pieces, their possible links between them and the defects of the coupon Cᵢ. Furthermore, this placement is optimized to limit material waste.

From this placement, a cutting program is developed, this program resulting from a conversion of the placement into orders to move the cutting tool of the cutting table.

The coupon Cᵢ is then transferred to the cutting zone of the table where the pieces are cut according to the cutting program (step S50). The cut pieces can then be unloaded (step S60) and the cutting method is resumed at step S20 with a new coupon Cᵢ₊₁.

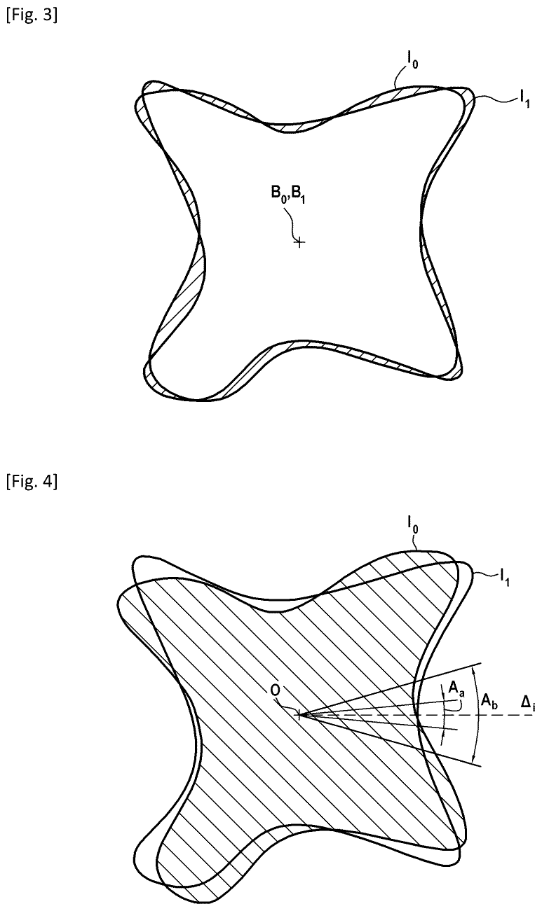

In relation to FIGS. 2 to 11, the main steps of the method for automatically positioning defects of a coupon Cᵢ according to the invention will now be described (corresponding to step S30 of the method described above).

In a first step S31, the contour of the coupon Cᵢ is digitized again using the scanner of the cutting table (the coupon is in a state ready for cutting).

A program then makes it possible to superimpose the two digital images of the contour of the coupon Cᵢ(step S32), namely the image of the coupon in its initial state I₀ that was acquired during step S10, and the image of the coupon I₁ ready for cutting that was acquired during step S31.

As represented in FIG. 3, this step is obtained by superimposing the respective barycenters B₀, B₁ of the two images of the coupon I₀, I₁.

Once they are superimposed, a calculation algorithm allows determining a rotation value to be applied to the digital image J₀, I₁ of at least one of the two contours of the coupon in order to minimize the total surface area of the zones of the two contours that do not overlap (i.e. that do not intersect), this rotation of the digital images of the contours of the coupon being carried out relative to the respective barycenters B₀, B₁ of the two contours after having been superimposed (step S33).

To this end, the algorithm calculates the surface area of the images I₀, I₁ of the two contours, then searches for the rotation value to be applied to one of them so that the value “(contour image I₀/contour image I₁) U (contour image I₁/contour image I₀)” is as small as possible.

In the example of FIG. 3, the zones whose surface area is to be minimized are the hatched zones.

During the next step (step S34), the rotation value determined in the previous step is applied to the position of each defect of the digital image I₀ of the coupon in its initial state in order to pre-position each defect inside the digital image I₁ of the coupon in its state ready for cutting.

The next step (step S35) consists in calculating a plurality of geometric transformations for locally minimizing the surface area of the zones of the images I₀, I₁ of the two contours that do not overlap (or intersect).

One of the geometric transformations previously calculated as a function of its position inside the contour is then applied to the position of each pre-positioned defect inside the digital image I₁ of the coupon in its state ready for cutting in order to accurately reposition it inside the digital image of the coupon in its state ready for cutting (step S36).

The algorithm implementing these last two steps S35 and S36 is described in more detail below.

Particularly, the algorithm for calculating the geometric transformation to be applied to each defect is carried out in a polar coordinate system whose the origin O is constituted by the respective barycenter B₀, B₁ of the images I₀, I₁ of the two contours.

In this reference frame, a discrete field of n angular sectors Δ₁, Δ₂, . . . , Δᵢ, . . . Δₙ covering the images I₀, I₁ of the two contours is constructed and a geometric transformation having rotation and homothety ratio components that are determined to locally minimize the surface area of the zones of the two contours that do not overlap (or intersect) are associated with each angular sector “Δᵢ”.

For example, an angular discretization of the images I₀, I₁ every degree will be chosen, which is equivalent to constructing a field with 360 angular sectors Δ₁, Δ₂, . . . , Δᵢ, . . . , Δ₃₆₀ and to determining 360 different geometric transformations (one transformation per angular sector “Δᵢ”). Of course, a different angular discretization could be chosen.

With each angular sector “Δᵢ”, the calculation algorithm then associates a geometric transformation composed of an angle rotation “Rᵢ” and of a ratio homothety “Hᵢ”, these two transformations being centered on the origin O of the polar coordinate system.

For each of the angular sectors “Δi”, the angle rotation component “Rᵢ” of the associated geometric transformation is calculated by the calculation algorithm in the following manner.

As represented in FIG. 4, an angular sector “Aₐ” of width 10° which is centered on “Δᵢ” is considered and a weight “Pₐ” of value 2 is assigned to this angular sector “Aₐ”.

In addition, another angular sector “Ab” of width 30° which is also centered on “Δᵢ” is considered and a weight “P_{b}” of value 1 is assigned to this other angular sector “A_{b}”.

The principle adopted here is to choose a first angular sector (“Aₐ”) narrower with a higher weight “Pₐ”, and a second angular sector (“A_{b}”) wider with a lower weight (“P_{b}”) in order to favor the search on the narrower angular sector for cases where the contour would be quite “cut” therein (thanks to the higher weight) while expanding the search if the contour is relatively linear (in this case the result of the calculation on the narrower angular sector would be approximately constant and the result of the calculation on the widest angular sector would become preponderant).

The values for the angular sectors and the weights are given here as an example. Of course, it could be envisaged to take other values, for example for a type of coupon presenting particular geometric characteristics.

For each angular sector “Δᵢ”, the transform I_{0-R} by the angle rotation “Rᵢ” of the image I₀ of the coupon in its initial state is then considered (see FIG. 5).

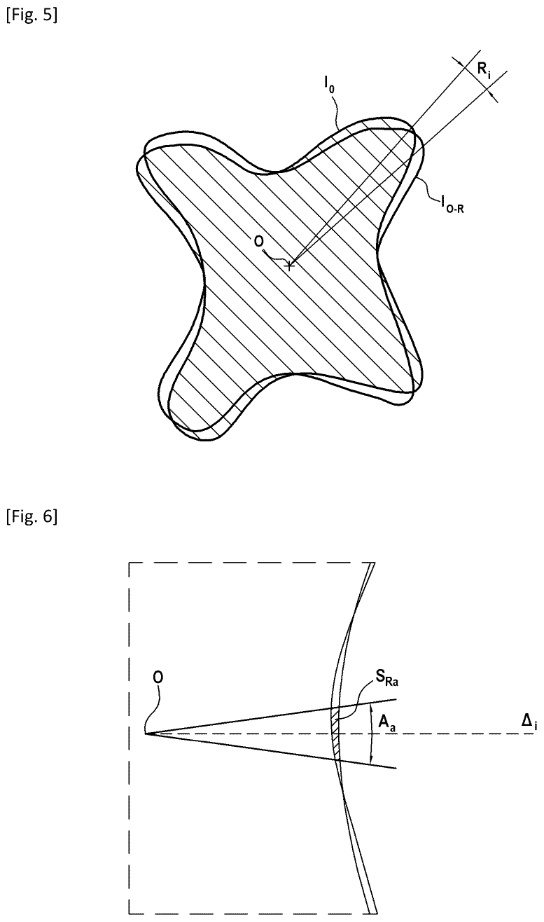

From these data, the surface area obtained by the following equation (and illustrated in FIG. 6) is define by S_{Ra}:

$${S}_{R a} = [ {I}_{0 - R} ⋂ {A}_{a} ) ∖ ( {I}_{1} ⋂ {A}_{a} ) ] ⋃ [ ( {I}_{1} ⋂ {A}_{a} ) ∖ ( {I}_{0 - R} ⋂ {A}_{a} ) ] \qquad [ Math . 1 ]$$

Similarly, still from these data, the surface area obtained by the following equation (and illustrated in FIG. 7) is defined by S_{Rb}:

$${S}_{R b} = [ ( {I}_{0 - R} ⋂ {A}_{b} ) ∖ ( {I}_{1} ⋂ {A}_{b} ) ] ⋃ [ ( {I}_{1} ⋂ {A}_{b} ) ∖ ( {I}_{0 - R} ⋂ {A}_{b} ) ] \qquad [ Math . 2 ]$$

The calculation algorithm will search by dichotomy for the value of the angle rotation “Rᵢ” that minimizes the sum: S_{Ra}Pₐ+S_{Rb}P_{b}.

Moreover, for each of the angular sectors “Δᵢ”, the homothety component “Hᵢ” of the associated geometric transformation is calculated by the calculation algorithm in the following manner.

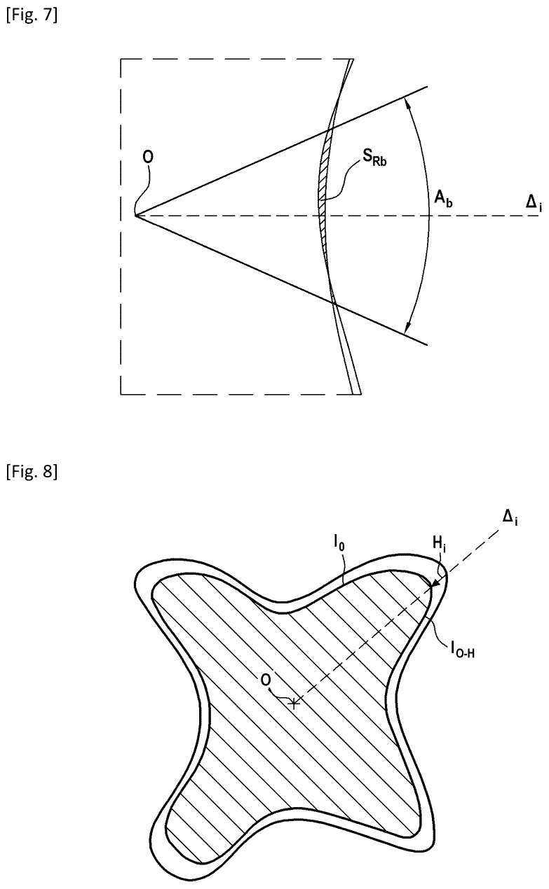

For each angular sector “Δᵢ”, the transform I_{0-H} by the ratio homothety “Hᵢ” of the image I₀ of the coupon in its initial state is considered (see FIG. 8).

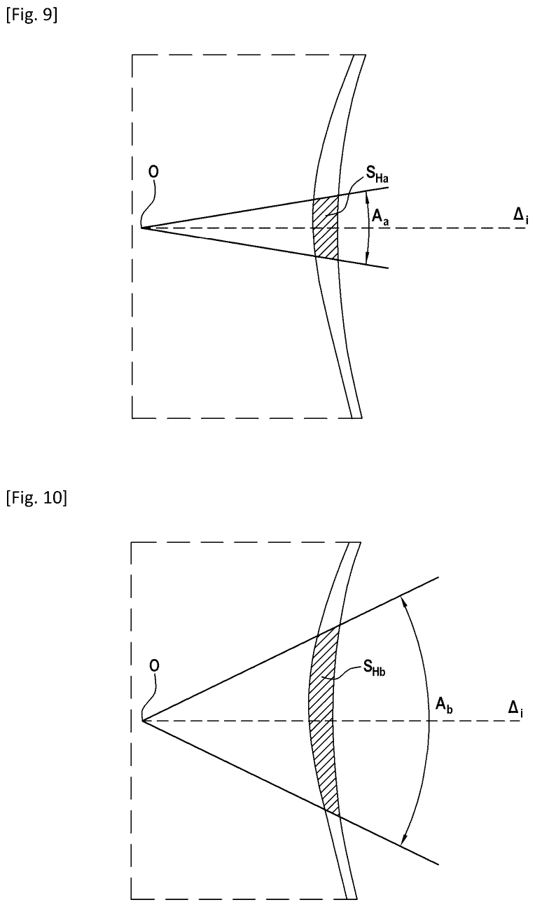

From these data, the surface area obtained by the following equation is defined by S_{Ha} (and illustrated in FIG. 9):

$${S}_{Ha} = [ ( {I}_{0 - H} ⋂ {A}_{a} ) ∖ ( {I}_{1} ⋂ {A}_{a} ) ] ⋃ [ ( {I}_{1} ⋂ {A}_{a} ) ∖ ( {I}_{0 - H} ⋂ {A}_{a} ) ] \qquad [ Math . 3 ]$$

Similarly, still from these data, the surface area obtained by the following equation is defined by S_{Hb} (and illustrated in FIG. 10)

$${S}_{Hb} = [ ( {I}_{0 - H} ⋂ {A}_{b} ) ∖ ( {I}_{1} ⋂ {A}_{b} ) ] ⋃ [ ( {I}_{1} ⋂ {A}_{b} ) ∖ ( {I}_{0 - H} ⋂ {A}_{b} ) ] \qquad [ Math . 4 ]$$

The calculation algorithm will search by dichotomy for the value of the homothety ratio “Hᵢ” that minimizes the sum:S_{Ha}Pₐ+S_{Hb}P_{b}.

Once the values of the angle rotation “Rᵢ” and of the homothety ratio “Hᵢ” of the geometric transformations have been calculated for all the angular sectors “Δᵢ”, the calculation algorithm provides for applying a geometric transformation to each pre-positioned defect inside the digital image I₁ of the coupon as a function of its polar coordinates.

More accurately, for each pre-positioned defect, the geometric transformation applies to each of the vertices of a polygon encompassing the contour of the defect.

To this end, for each vertex of each pre-positioned defect, the method performs a linear interpolation between the values closest to the discrete field calculated previously.

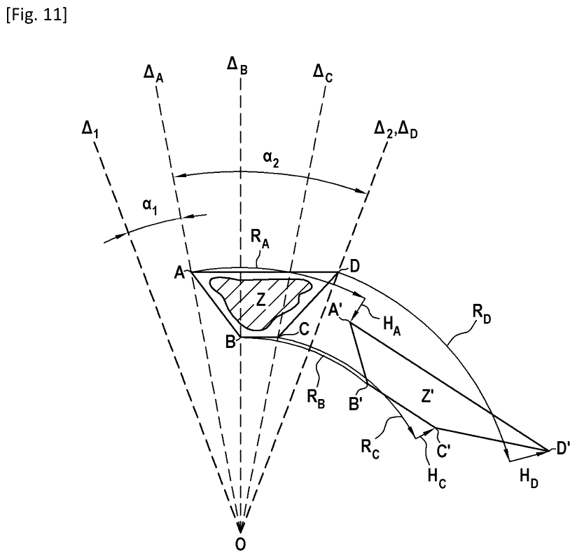

FIG. 11 shows one example of application of such a linear interpolation to a pre-positioned defect Z whose contour is encompassed in a polygon ABCD.

If Δ_{A}, Δ_{B}, Δ_{c}, and Δ_{D} refer to the respective angular coordinates of the vertices A, B, C, D of the polygon encompassing the contour of a pre-positioned defect, the calculation algorithm will determine the angle rotations R_{A}, R_{B}, R_{C}, and R_{D} and the homothety ratios H_{A}, H_{B}, H_{C}, and H_{D} of the geometric transformations to be applied.

For each vertex of the polygon, “Δ₁” and “Δ₂” refer to the consecutive angular coordinates in the discrete field calculated previously which frame the angular coordinate of the vertex in question. In the example of an angular discretization of the images I₀, I₁ every degree, there is therefore Δ₂−Δ₁=1°.

In addition, due to an angular discretization of the images I₀, I₁ every degree, for the vertex A of the polygon encompassing the contour of the defect Z, the following equality: Δ_{A}=α₁Δ₁+α₂Δ₂ can be written in which ai is the angle between Δ₁ and Δ_{A} and α₂ is the angle between Δ_{A} and Δ₂. Of course, the same types of equalities can be written for the other vertices B, C, D of the polygon.

More generally (i.e. angular discretization not necessarily every degree), α₁ and α₂ are coefficients whose sum is equal to 1 (and which correspond to the value of the corresponding angle divided by the value of the angle Δ₂−Δ₁).

With R_{Δ1}, H_{Δ1} and R_{Δ2}, H_{Δ2} referring to the values of the angle rotation and of the homothety ratio of the geometric transformations calculated respectively for the angular coordinates Δ₁ and Δ₂ framing the angular coordinate of the vertices A, B, C, D of the polygon, the algorithm gives the values of the geometric transformations applied to the vertex A by the following equations: R_{A}=α₁ R_{Δ1}+α₂R_{Δ2} and H_{A}=α₁ H_{Δ1}+α₂H_{Δ2}.

Of course, the same types of equations are determined for the other vertices B, C, D of the polygon.

When these equations are applied to all the vertices A, B, C, D of the polygon encompassing the contour of the pre-positioned defect Z, the polygon A′B′C′D′ represented in FIG. 11 and which therefore encompasses the defect Z′ repositioned accurately inside the digital image of the coupon in its state ready for cutting is thus obtained.

This calculation operation is repeated for all the defects pre-positioned inside the digital image I₁ of the coupon in its state ready for cutting.

1.-10. (canceled)

11. A method for automatically positioning defects in a coupon of flexible material with non-homogeneous characteristics from which pieces are intended to be cut, comprising the successive steps of:
obtaining a digital image of the contour of the coupon in its initial state and the position of its defects;
after repositioning the coupon in a state ready for cutting, obtaining a new digital image of the contour of the coupon;
superimposing the digital images of the contours of the coupon in its initial state and in its state ready for cutting;
determining a rotation value to be applied to at least one of the two contours in order to minimize the total surface area of the zones delimited by the two contours that do not overlap;
applying the rotation value to the position of each defect of the digital image of the coupon in its initial state in order to pre-position each defect inside the digital image of the coupon in its state ready for cutting;
determining a plurality of geometric transformations to locally minimize the surface area of the zones of the two contours that do not overlap; and
applying to the position of each pre-positioned defect inside the digital image of the coupon in its state ready for cutting, one of the geometric transformations as a function of the position of the defect inside the contour of the coupon in its initial state in order to accurately reposition the defect inside the digital image of the coupon in its state ready for cutting.

12. The method according to claim 11, wherein the rotation of the digital images of the contours of the coupon is carried out relative to the respective barycenters of the two contours after having been superimposed.

13. The method according to claim 11, wherein the geometric transformations each comprise a rotation component and a homothety ratio component.

14. The method according to claim 13, wherein, in a polar coordinate system whose origin is constituted by the respective barycenter of the two contours, a discrete field of angular sectors covering the two contours is constructed and geometric transformations whose rotation and homothety ratio components are determined are associated with each angular sector in order to locally minimize the surface area of the zones of the two contours that do not intersect.

15. The method according to claim 14, wherein the rotation and homothety ratio components of each geometric transformation are determined by dichotomy in order to obtain the rotation and homothety ratio values that minimize the surface area of the non-overlapping zones of the portions of the two contours concerned by the angle value associated with the geometric transformation.

16. The method according to claim 11, wherein the step of applying one of the geometric transformations to each pre-positioned defect applies to each of the vertices of a polygon encompassing the contour of the defect.

17. The method according to claim 16, wherein, for each vertex of each polygon encompassing the contour of a defect, the two angles that geometrically frame this vertex are identified, and a combination of the rotation and homothety ratio values of the two geometric transformations associated with the two corresponding angle values is applied to the coordinates of the vertex.

18. A method for cutting pieces from coupons of flexible material with non-homogeneous characteristics, comprising:
a step of digitizing the contour of the coupons in their initial state and the position of their defects;
for each coupon, a new step of digitizing the contour of the coupon on a digitizing and cutting table;
a step of automatically positioning the defects of the coupon according to claim 11;
a step of placing pieces to be cut from the coupon; and
a step of cutting the pieces.

19. A computer program including instructions for the execution of the steps of the method for automatically positioning defects in a coupon of flexible material with non-homogeneous characteristics according to claim 11.

20. A computer-readable recording medium on which is recorded a computer program comprising instructions for the execution of the steps of the method for automatically positioning defects in a coupon of flexible material with non-homogeneous characteristics according to claim 11.
